(19) United States
(12) Patent Application Publication
(10) Pub. No.: US 2026/0236452 A1
(43) Pub. Date: Aug. 13, 2026

(54) SIMULATING STRONG CONSISTENCY ACROSS SEPARATE WRITE AND READ SYSTEMS

(71) Applicant: INTUIT INC., Mountain View, CA (US)

(72) Inventor: Kiran Kumar Reddy DIGAVINTI, Fremont, CA (US)

(21) Appl. No.: 19/051,715

(22) Filed: Feb. 12, 2025

(51) Int. Cl. G06F 16/23

(52) U.S. Cl. CPC G06F 16/2365

(57) ABSTRACT

Aspects of the present disclosure provide techniques for maintaining data consistency between a write database and a read database. Embodiments include receiving, via an orchestrator, updated data written to the write database during a write operation occurring after a most recent data sync between the write database and the read database. Embodiments include storing, via the orchestrator, the updated data in a data storage that is separate from the write database and the read database. Embodiments include receiving, via the orchestrator, a request associated with reading the updated data from the read database before a next data sync between the write database and the read database. Embodiments include reading, via the orchestrator and based on receiving the request, the updated data from the data storage. Embodiments include passing the updated data from the orchestrator to the read database.

### INTRODUCTION

Aspects of the present disclosure relate to techniques for simulating strong consistency in computing environments with separate write and read systems, such as in a Command Query Responsibility Segregation (CQRS) architecture.

### BACKGROUND

Every year millions of people, businesses, and organizations around the world utilize software applications to assist with countless aspects of life. Software applications often utilize databases, and such databases may be updated frequently.

In some cases, a software application may have a separate read system and write system, each with its own database. For example, having separate read and write systems may provide improved efficiency, as read and write requests may be handled separately, such as using different computing resources, avoiding bottlenecks and overutilization of one system. Such an implementation may be particularly beneficial in distributed systems with large amounts of read and write traffic. However, maintaining consistency across separate read and write systems can be challenging. For example, such systems are typically synchronized at particular points in time, such as based on events, and there may be gaps in time between when changes are made at the write system and when such changes are received at the read system. Thus, read requests in existing systems may sometimes result in stale data being provided to a user. This problem is exacerbated in systems with high write volumes or complex data synchronization requirements.

As such, there is a need in the art for improved techniques of ensuring consistency between a separate read system and write system in a software application.

### BRIEF SUMMARY

Certain embodiments provide a method for maintaining data consistency between a write database and a read database. The method generally includes: receiving, via an orchestrator communicatively coupled to the write database and the read database, updated data written to the write database during a write operation occurring after a most recent data sync between the write database and the read database; storing, via the orchestrator, the updated data in a data storage that is separate from the write database and the read database; receiving, via the orchestrator, a request from an application programming interface (API) model on behalf of a client device, the request associated with reading the updated data from the read database before a next data sync between the write database and the read database; reading, via the orchestrator and based on receiving the request from the API model, the updated data from the data storage; and passing the updated data from the orchestrator to the read database.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is a diagram illustrating example computing components related to existing data consistency techniques, according to certain embodiments.

FIG. 2 is a diagram illustrating example computing components related to maintaining data consistency between a write database and a read database, according to certain embodiments.

FIG. 3 is a diagram depicting example code related to maintaining data consistency between a write database and a read database, according to certain embodiments.

FIG. 4 is a diagram depicting example code related to maintaining data consistency between a write database and a read database, according to certain embodiments.

FIG. 5 is a diagram depicting example code related to maintaining data consistency between a write database and a read database, according to certain embodiments.

FIG. 6 is a diagram depicting an example user interface screen related to maintaining data consistency between a write database and a read database, according to certain embodiments.

FIG. 7 is a diagram depicting an example user interface screen related to maintaining data consistency between a write database and a read database, according to certain embodiments.

FIG. 8 is a diagram depicting an example user interface screen related to maintaining data consistency between a write database and a read database, according to certain embodiments.

FIG. 9 is a diagram depicting an example user interface screen related to maintaining data consistency between a write database and a read database, according to certain embodiments.

FIG. 10 is a diagram depicting an example user interface screen related to maintaining data consistency between a write database and a read database, according to certain embodiments.

FIG. 11 is a diagram depicting an example user interface screen related to maintaining data consistency between a write database and a read database, according to certain embodiments.

FIG. 12A is a diagram depicting a first portion of example code related to maintaining data consistency between a write database and a read database, according to certain embodiments.

FIG. 12B is a diagram depicting a second portion of example code related to maintaining data consistency between a write database and a read database, according to certain embodiments.

FIG. 13 is a diagram depicting example techniques for cache management related to maintaining data consistency between a write database and a read database, according to certain embodiments.

FIG. 14 depicts example operations related maintaining data consistency between a write database and a read database, according to certain embodiments.

FIG. 15 depicts an example processing system for maintaining data consistency between a write database and a read database, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for maintaining data consistency between a write database and a read database.

Computing applications such as those utilizing a command query responsibility segregation (CQRS) architecture may have separate read and write systems. For example, segregating a read system and an associated read database from a write system and an associated write database may enhance application scalability and performance. However, such segregation can lead to eventual consistency issues, where the read system might present outdated data to users due to delays in synchronizing updates from the write system. Eventual consistency is a consistency model in distributed computing where updates to a system eventually propagate to all nodes, but immediate consistency is not guaranteed. This inherent eventual consistency problem in segregated systems such as those utilizing a CQRS architecture can result in scenarios where users see stale or incorrect data, potentially leading to poor user experiences and erroneous decisions. The present disclosure introduces techniques that involve using a distributed cache and, in some embodiments, data merging functionality such as through the use of common table expressions (CTEs), to mitigate the consistency challenges in such systems, ensuring that up-to-date information is provided in response to read requests even in distributed systems. A distributed system is a system in which components located on networked computers communicate and coordinate their actions by passing messages, often aiming to achieve a common goal.

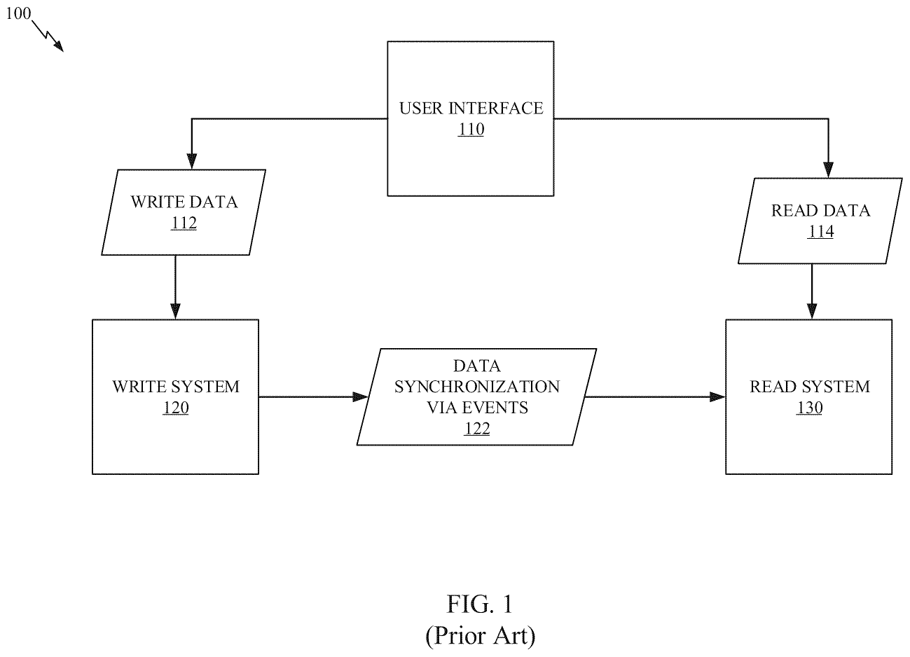

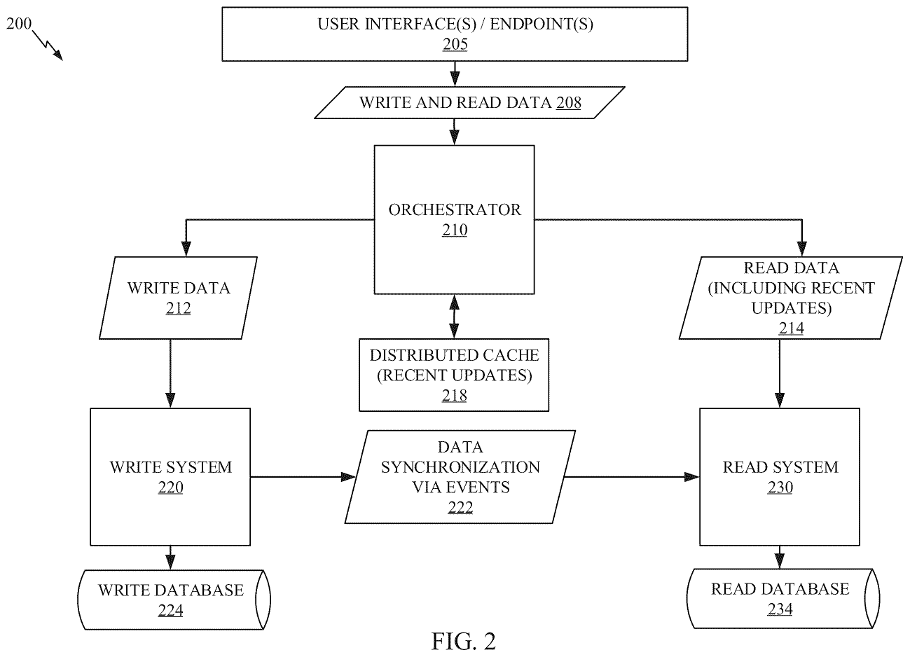

As described in more detail below with respect to FIG. 1, many existing distributed systems involve read requests and write requests being transmitted directly to a read system and a write system, respectively, and the read system and the write system being synchronized with one another in an event-driven manner. To overcome the consistency issues that may arise in such environments, techniques described herein involve introducing an orchestrator that maintains a distributed cache and that receives all read requests and write requests prior to such requests being transmitted to the read system and write system. As described in more detail below with respect to FIG. 2, the orchestrator may store recent updates that are made to the write system via write requests in the distributed cache prior to transmitting such write requests to the write system. Then, when the orchestrator receives a read request that relates to a recent update, the orchestrator may retrieve the applicable recent update from the distributed cache and provide the recent update to the read system along with the read request. The read system may, upon processing the read request, merge the received recent update with corresponding data stored in the read system, and may respond to the read request based on the merged data. In some embodiments, common table expressions (CTEs) may be used to merge recent updates with corresponding data from the read database. A CTE is a temporary result set in SQL that can be referenced within a SELECT, INSERT, UPDATE, or DELETE statement. Thus, strong consistency between the write system and the read system may be “simulated” even before recent updates to the write system have been synchronized with the read system, as the orchestrator may ensure that the read system is able to merge such recent updates with its own data as applicable in response to particular read requests.

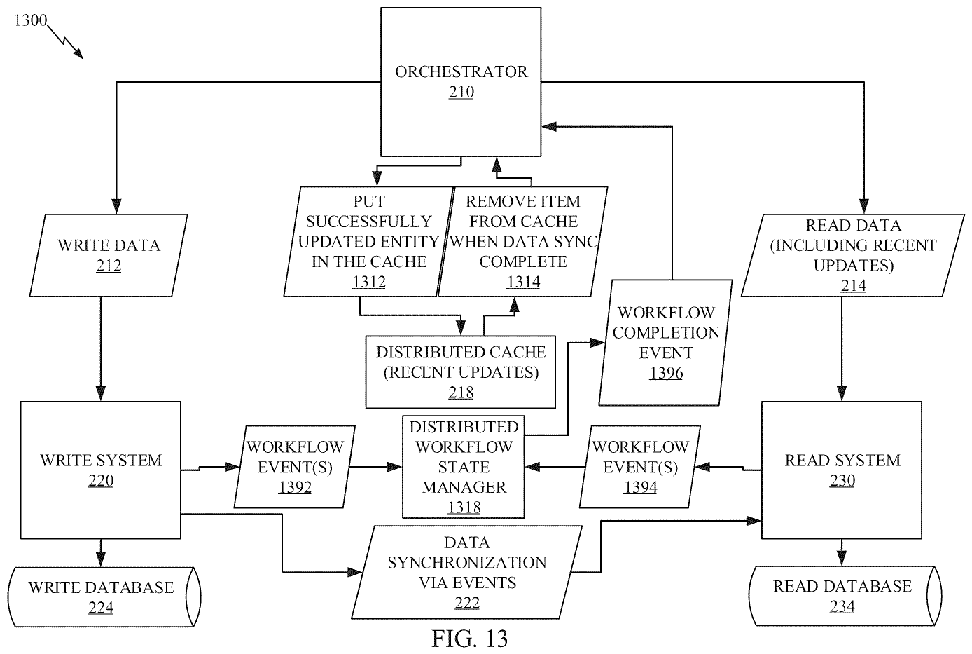

The distributed cache may be managed on an ongoing basis in such a manner as to ensure that recent updates are evicted from the cache when no longer needed (e.g., when the read system has been synchronized with those recent updates), thereby improving resource efficiency. For example, as described in more detail below with respect to FIG. 13, a distributed workflow state manager may track ongoing synchronization workflows and may notify the orchestrator when a synchronization workflow relating to a particular recent update has been completed, at which point the orchestrator may evict that particular recent update from the distributed cache.

Techniques described herein improve the technical field of data storage and retrieval in a number of ways. For instance, by utilizing a distributed cache to store recent updates to a write system and sending such cached recent updates to a read system along with read requests as applicable, aspects of the present disclosure enable strong consistency between separate read and write systems in a software application to be maintained even when the read and write systems have not yet been synchronized following the recent updates. Thus, techniques described herein overcome data consistency issues with existing systems, preventing cases in which inaccurate or stale data would otherwise be provided in response to read requests while still obtaining the efficiency benefits of maintaining separate read and write systems.

Furthermore, by dynamically managing the distributed cache based on events indicating the completion of synchronization events, certain embodiments of the present disclosure provide additional technical improvements by removing recent updates from the distributed cache when the read system has been synchronized with such updates, thereby improving storage efficiency.

The CQRS architecture offers significant benefits in systems requiring scalability and performance by separating read and write operations. However, it introduces challenges, particularly with eventual consistency, where data discrepancies can occur between the command (write) and query (read) models. Aspects of the present disclosure overcome these challenges using a distributed cache and merging techniques such as based on CTEs, ensuring more consistent data across the system without compromising performance. While CQRS brings complexities, particularly in data synchronization and cache management, implementing robust concurrency control, optimizing queries, and refining cache strategies can effectively mitigate these issues. By doing so, the advantages of CQRS may be leveraged while maintaining system reliability and data integrity, ensuring a seamless user experience even in distributed environments.

### Example Existing Computing Components Related to Data Consistency

FIG. 1 is a diagram 100 illustrating example computing components related to existing data consistency techniques, according to certain embodiments. Illustration 100 generally relates to prior techniques that include certain challenges overcome by aspects of the present disclosure.

In diagram 100, a write system 120 and a read system 130 are separate from one another, and a user interface 110 provides write data 112 to the write system 120 and read data 114 to the read system 130.

Write system 120 and read system 130 may be associated with a computing application, such as a distributed application, that receives and processes write requests and read requests (e.g., based on input provided via user interface 110). For example, write system 120 may be associated with a write database and read system 130 may be associated with a read database, such as according to a Command Query Responsibility Segregation (CQRS) architecture. CQRS, for example, divides a system into separate components for handling commands (write operations) and queries (read operations). This design improves scalability and allows each component to be optimized for its specific task.

Data synchronization 122 may occur in an event-driven manner, such as synchronizing read system 130 with write system 120 based on the occurrence of events (e.g., indicating changes having been made to write system 120). Data synchronization 122 may result in an eventually consistent system. In a distributed CQRS system, eventual consistency means that changes made in the command system might take some time to reflect in the query system. This lag can lead to temporary inconsistencies where the data presented to users is outdated.

Write data 112 may comprise one or more write requests, such as based on input received via a user interface 110, and may involve writing data to a write database associated with write system 120. Read data 114 may comprise one or more read requests, such as based on input received via a user interface 110, and may involve reading data from a read database associated with read system 130. If a read request in read data 114 is received by read system 130 after a change has been made to write system 120 (e.g., via a write request in write data 112) but before read system 130 has been synchronized with write system 120 following that change (e.g., at data synchronization 122), then read system 130 may respond to the read request based on stale data. This problem is exacerbated in systems with high write volumes or complex data synchronization requirements. Inconsistent data can negatively impact user trust and lead to decisions based on outdated or incorrect information. For example, in accounting software, eventual consistency can cause a delay in reflecting reclassified transactions, leading to users seeing outdated financial categories that could result in inaccurate reporting and financial decision-making. In an e-commerce platform, users might see incorrect inventory levels or outdated prices, leading to poor customer satisfaction.

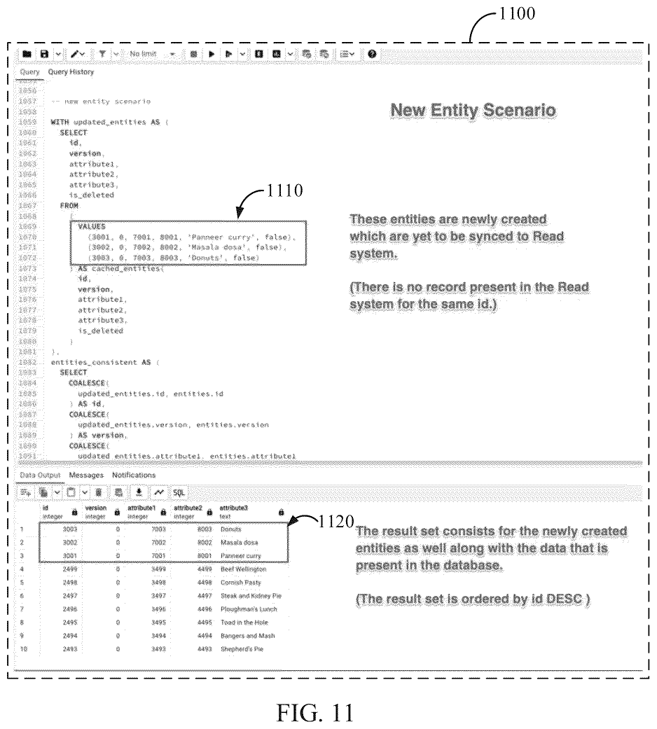

Prior solutions to eventual consistency include using distributed transactions (e.g., performing transactions across two or more data stores such as databases and completing the transactions only if they successfully complete at all of the two or more data stores) or event sourcing (e.g., an architectural design pattern where changes that occur in a domain are immutably stored as events in a log). However, these methods can introduce complexity and performance overheads (e.g., because data cannot be written to a write system until it is also written to a read system as part of a coordinated distributed transaction or because event sourcing still may result in eventual consistency issues). As described herein, techniques described herein offer a simpler, more efficient, and effective alternative to these prior solutions, making use of the scalability of separate read and write systems while maintaining strong consistency. For example, as described in more detail below with respect to FIGS. 2-15, aspects of the present disclosure involve using a distributed cache and a mechanism such as common table expressions (CTEs) in relational databases to merge recent updates into the read system in a dynamic and efficient manner. Thus, techniques described herein simulate strong consistency by ensuring that recent updates are reflected in the read system, even before full synchronization occurs.

### Example Computing Components Related to Maintaining Data Consistency Between a Read Database and a Write Database

FIG. 2 is a diagram 200 illustrating example computing components related to maintaining data consistency between a write database and a read database, according to certain embodiments. Diagram 200 generally represents improved techniques compared to those discussed above with respect to diagram 100 of FIG. 1.

In diagram 200, write system 220 and read system 230 represent separate write and read systems, such as similar to write system 120 and read system 130 of FIG. 1. For example, write system 220 and read system 230 may be part of a CQRS architecture, such as in a distributed computing application. Write system 220 is associated with a write database 224 and read system 230 is associated with a read database 234. Write database 224 and read database 234 generally represent data storage entities that store data and from which data can be retrieved.

Data synchronization 222 may occur in an event-driven manner, such as synchronizing read system 230 with write system 220 based on the occurrence of events (e.g., indicating changes having been made to write system 220). Data synchronization 222 may result in an eventually consistent system (e.g., read database 234 may be eventually consistent with write database 234).

User interface(s)/endpoint(s) 205 generally represent one or more user interfaces, computing applications, components, devices, and/or other types of endpoints that may write data to write system 220 and/or read data from read system 230. For example, write and read data 208 may comprise one or more write requests and/or one or more read requests. In one example, write and read data 208 comprises application programming interface (API) calls to write data or read data.

According to embodiments of the present disclosure, an orchestrator 210 may receive all write and read data 208 from user interface(s)/endpoint(s) 205, and may serve as an intermediary component between user interface(s)/endpoint(s) 205 and write system 220 and read system 230. In distributed systems, an orchestrator is a component that manages the execution of tasks, ensuring that they are carried out in the correct sequence and handling dependencies between tasks. Orchestrator 210 is associated with a distributed cache 218 for storing recent updates to write system 220. Distributed cache 218 may, for example, be a data storage entity from which data may be efficiently retrieved. In certain aspects, orchestrator 210 may store, in distributed cache 218, all successful write operations immediately after such write operations are successfully completed. For example, when orchestrator 210 receives a write request (e.g., in write and read data 208), orchestrator 210 may provide the write request to write system 220 (e.g., as write data 212) and, upon determining that the write request was successfully completed (e.g., based on receiving a confirmation from write system 220), may store the data from the write request in distributed cache 218 as a recent update. Subsequently, upon receiving a read request (e.g., in write and read data 208) that relates to the recent update (e.g., a read request for data affected by the recent update), orchestrator 210 may retrieve the recent update from distributed cache 218 and provide the recent update along with the read request (e.g., as read data 214) to read system 230.

Read system 230 may use the recent update, such as along with relevant data from read database 234, to respond to the read request. For example, read system 230 may merge the recent update with corresponding data from read database 234, such as using common table expressions (CTEs), and respond to the read request based on the merged data (e.g., the relevant data from read database 234 updated based on the recent update). For instance, read system 230 may provide a response to orchestrator 210, and orchestrator 210 may provide the response to the component in user interface(s)/endpoint(s) 205 that originally sent the read request. Alternatively, read system 230 may respond directly to the component in user interface(s)/endpoint(s) 205 that originally sent the read request. Thus, techniques described herein enable strong consistency between write system 220 and read system 230 to be maintained even when read system 230 has not yet been synchronized with write system 220 after particular write requests.

Once read system 230 has been synchronized with write system 220 at data synchronization 222 after the write request (e.g., such that read system 230 is updated based on the recent update), orchestrator 210 may remove the recent update from distributed cache 218. Techniques for efficient management of distributed cache 218 are described in more detail below with respect to FIG. 13.

Because successful write operations are immediately stored in distributed cache 218, these recent changes may be quickly accessed and included in subsequent read operations. This ensures that users receive up-to-date information from the read system, even before the full synchronization with the database occurs, thus maintaining a consistent and responsive user experience.

### Example Application Programming Interface Model for Maintaining Data Consistency Between a Write Database and a Read Database

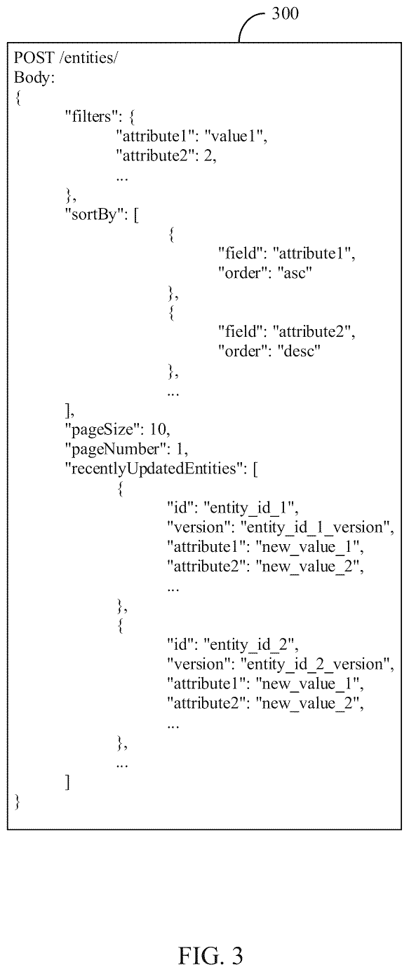

FIG. 3 is a diagram 300 depicting example code related to maintaining data consistency between a write database and a read database, according to certain embodiments. For example, diagram 300 generally represents an application programming interface (API) model that demonstrates how recent updates may be sent to read system 230 of FIG. 2 along with read requests, such as via POST requests supported by hypertext transfer protocol (HTTP).

For example, the code in diagram 300 comprises a POST request that is used to send a recent update by specifying two attributes (attribute1 and attribute2), specifying that the two attributes can be sorted in ascending or descending order, and specifying, for each of two entities that are recently updated, the identifier of the entity, a version of the entity, and new values for the two attributes with respect to the entity (e.g., values that have been changed via the recent update). Versions of entities may be maintained in order to implement a versioning scheme. Versioning is a process of assigning unique version numbers to entities or data sets to track changes over time, often used in systems where maintaining a history of changes is critical.

### Example Query Structure for Maintaining Data Consistency Between a Write Database and a Read Database

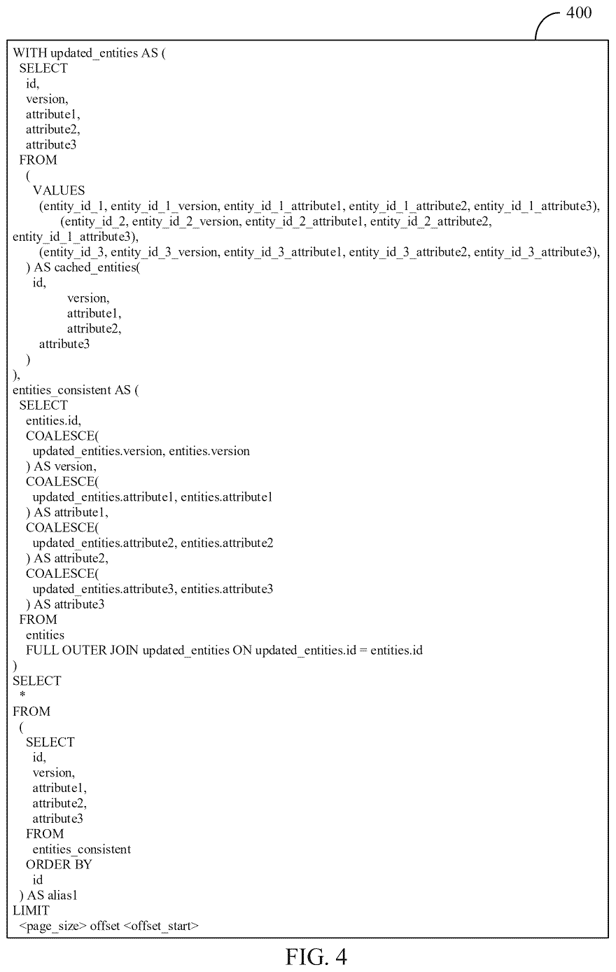

FIG. 4 is a diagram 400 depicting example code related to maintaining data consistency between a write database and a read database, according to certain embodiments. For example, diagram 400 generally represents a structured query language (SQL) query that demonstrates how recent updates may be merged with data from read system 230 of FIG. 2.

For example, the code in diagram 400 involves using common table entities (CTEs) to merge updated data with existing records via particular statements (e.g., SELECT statements). In the depicted example, the CTE named updated_entities selects the id, version, attribute1, attribute2, and attribute3 of a set of entities from a values statement. The CTE named entities_consistent joins the CTE updated_entities with the entities table using a FULL OUTER JOIN, matching on the id column. The FULL OUTER JOIN ensures that all the write scenarios like Create, Update and Delete of new entities are taken care of. FULL OUTER JOIN is a type of SQL join that returns all records when there is a match in either the left or right table, along with unmatched rows from both tables. The COALESCE function is used to select the non-null value between the updated attributes and the original attributes for each column in the output. The result is a table that lists all entities, with their consistent attributes, whether updated or not. The final SELECT statement selects all columns from the entities_consistent table and applies an ORDER BY clause to order the results by id, then applies a LIMIT and OFFSET clause to return the first <page_size> rows starting from offset start.

By merging recently updated entities into the read database using CTEs in a relational database setting, the read system can provide consistent and up-to-date data to the read API, even if the updates have not yet propagated to all systems in the CQRS-based architecture. A relational database is a type of database that stores data in tables with rows and columns, using structured query language (SQL) for querying and managing data. It is noted that a relational database is included as an example, and other data storage and retrieval mechanisms may be used with techniques described herein.

### Example Mapping of Cached Entities to Database Entities

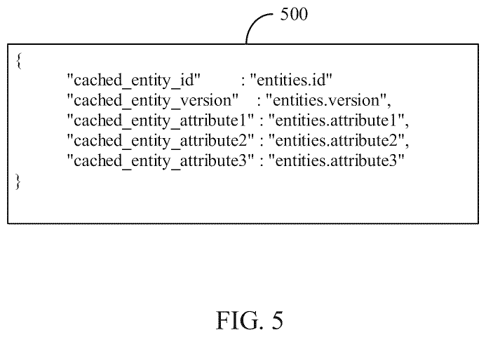

FIG. 5 is a diagram 500 depicting example code related to maintaining data consistency between a write database and a read database, according to certain embodiments. For example, diagram 500 generally represents a library that can be consumed by read system 230 of FIG. 2, and comprises a mapping that maps each of the attributes in the cached entity (e.g., in distributed cache 218 of FIG. 2) to the corresponding database columns (e.g., in read database 234). The read system may dynamically generate a SQL query with CTEs (e.g., the query represented in FIG. 4) using this mapping, such as based on receiving the cached entity information as a recent update as described above with respect to FIG. 3.

For example, the code in diagram 500 includes a mapping of an identifier, version, and multiple attributes of a cached entity to an identifier, version, and multiple attributes of a corresponding entity in the read database.

It is noted that the particular code and mechanisms, such as CTEs and relational databases, discussed herein are included as examples, and other implementations are possible without departing from the scope of the present disclosure.

### Example User Interface Screens

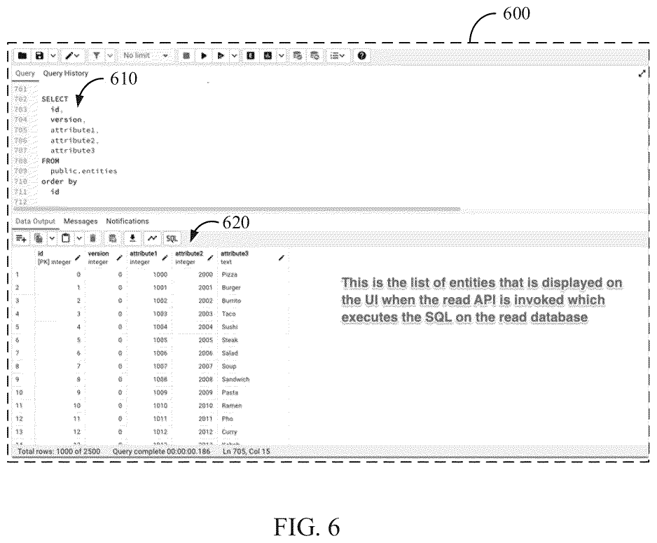

FIG. 6 is a diagram depicting an example user interface screen 600 related to maintaining data consistency between a write database and a read database, according to certain embodiments. For example, user interface screen 600 may represent a screen of a user interface in user interface(s)/endpoint(s) 205 of FIG. 2 that displays a query 610 (e.g., generated by a read system based on a read request input by a user or submitted by a component) and a data output 620 in response to the query. For example, the query 610 may have been generated (e.g., by the read system) based on a read request, and the data output 620 may represent a response to the read request from read system 230 of FIG. 2.

Query 610 generally includes a request for an identifier, a version, attribute 1, attribute2, and attribute3 from all public entities, ordered by identifier.

Data output 620 generally includes the requested data from each entity in the order specified in query 610. For example, the read request may have been received by orchestrator 210 of FIG. 2 and passed to read system 230 of FIG. 2 (e.g., there may not be any applicable recent updates stored in the distributed cache, so no recent updates may have been provided to the read system with the read request). The read system may have generated query 610 based on the read request, and may have returned the information in data output 620 based on retrieving the requested data from the read database.

It is noted that the queries described herein are intentionally made simple without complex joins. However, techniques described herein can be extended to queries that are complex with nested and/or multiple joins.

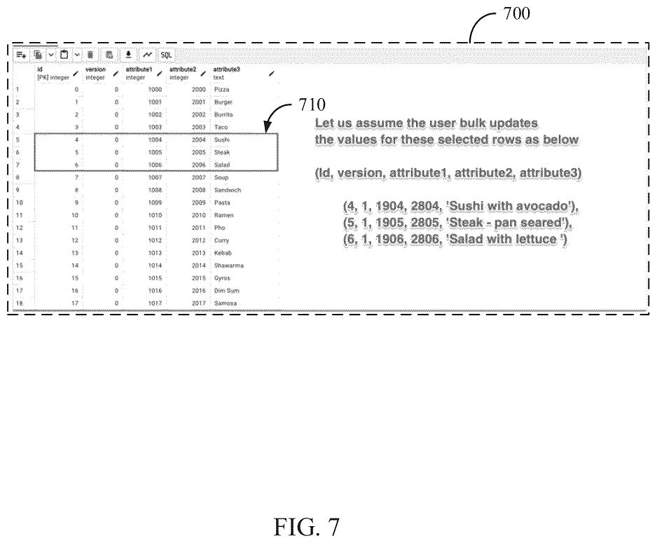

FIG. 7 is a diagram depicting another example user interface screen 700 related to maintaining data consistency between a write database and a read database, according to certain embodiments. For example, user interface screen 700 may represent a screen of a user interface in user interface(s)/endpoint(s) 205 of FIG. 2 that displays values 710 (e.g., that may be updated by a user) of three entities. For example, values 710 may be updated via a write request to bulk update the values 710 shown in user interface screen 700 to the following: (4, 1, 1904, 2804, ‘Sushi with avocado’), (5, 1, 1905, 2805, ‘Steak—pan seared’), (6, 1, 1906, 2806, ‘Salad with lettuce’), where each such update corresponds to (ID, version, attribute1, attribute2, attribute3).

The write request to update values 710 may be received by orchestrator 210 of FIG. 2, and may be sent to write system 220 of FIG. 2. The orchestrator may, upon determining that the write request was successfully completed by the write system (e.g., based on receiving a confirmation from the write system), store the updates made via the write request as recent updates in distributed cache 218 of FIG. 2.

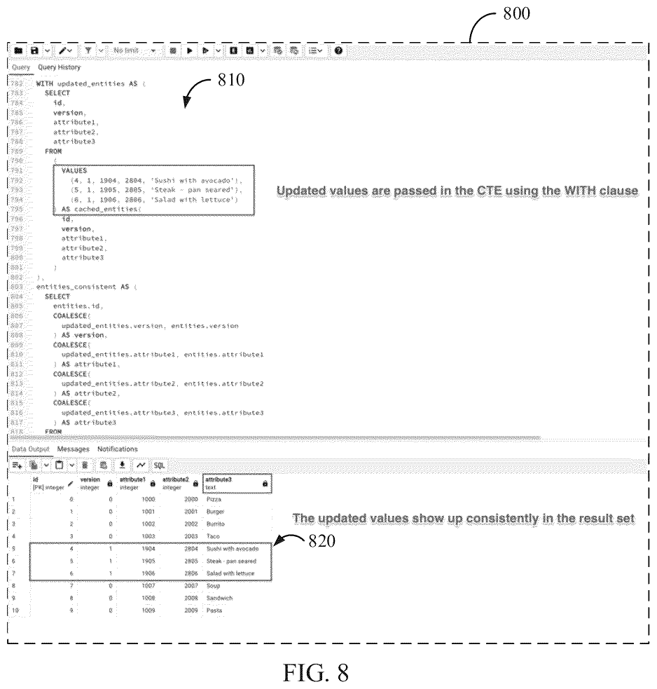

FIG. 8 is a diagram depicting another example user interface screen 800 related to maintaining data consistency between a write database and a read database, according to certain embodiments. For example, user interface screen 800 may represent a screen of a user interface in user interface(s)/endpoint(s) 205 of FIG. 2 that displays that displays a query 810 (e.g., generated by a read system based on a read request input by a user or submitted by a component) and a data output 820 in response to the query. For example, the query 810 may correspond to a read request that is received after the write request described above with respect to FIG. 7 has been processed but before the read system and the write system have been synchronized after the processing of the write request, and the data output 820 may represent a response to the read request from read system 230 of FIG. 2.

Query 810 generally includes a request for an identifier, a version, attribute 1, attribute2, and attribute3 from all public entities, ordered by identifier, and also includes the applicable recent update(s) from the distributed cache. For example, query 810 may be similar to the query shown and described with respect to FIG. 4. For example, query 810 may use common table entities (CTEs) to merge updated data with existing records via particular statements (e.g., SELECT statements). In the depicted example, the CTE named updated_entities selects the id, version, attribute1, attribute2, and attribute3 of a set of entities from a values statement that includes the updated values (e.g., from the distributed cache). The CTE named entities_consistent joins the CTE updated_entities with the entities table using a FULL OUTER JOIN, matching on the id column. The FULL OUTER JOIN ensures that all the write scenarios like Create, Update and Delete of new entities are taken care of. The COALESCE function is used to select the non-null value between the updated attributes and the original attributes for each column in the output. The result is a table that lists all entities, with their consistent attributes, whether updated or not. The final SELECT statement selects all columns from the entities_consistent table and applies an ORDER BY clause to order the results by id, then applies a LIMIT and OFFSET clause to return the first <page_size> rows starting from offset start.

Data output 820 generally includes the requested data from each entity in the order specified in input query 810. For example, the read request may have been received by orchestrator 210 of FIG. 2 and passed to read system 230 of FIG. 2 along with the applicable recent updates from distributed cache 218 of FIG. 2, which in this case include the updated values (4, 1, 1904, 2804, ‘Sushi with avocado’), (5, 1, 1905, 2805, ‘Steak-pan seared’), (6, 1, 1906, 2806, ‘Salad with lettuce’). The read system may have generated query 810 based on the read request and the recent updates, and may have returned the information in data output 820 based on retrieving the requested data from the read database and merging the retrieved data with the updated data based on the CTEs in query 810. As shown, the updated values may appear consistently in output data 820 even though the read database has not yet been synchronized with the write database after the recent updates were made to the write database.

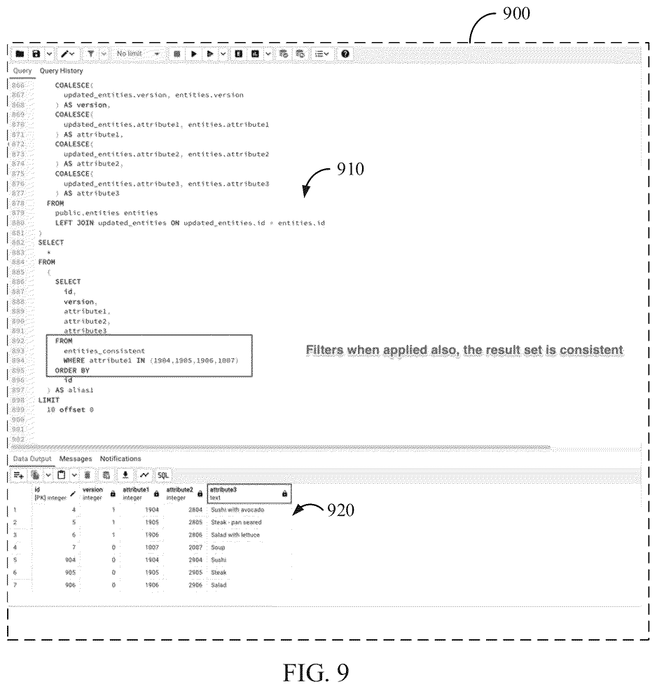

FIG. 9 is a diagram depicting another example user interface screen 900 related to maintaining data consistency between a write database and a read database, according to certain embodiments. For example, user interface screen 900 may represent a screen of a user interface in user interface(s)/endpoint(s) 205 of FIG. 2 that displays that displays a query 910 (e.g., generated by a read system based on a read request input by a user or submitted by a component) and a data output 920 in response to the query. For example, the query 910 may correspond to a read request that is received after the write request described above with respect to FIG. 7 has been processed but before the read system and the write system have been synchronized after the processing of the write request, and the data output 820 may represent a response to the read request from read system 230 of FIG. 2.

Generally, user interface screen 900 may represent an example where a filter is applied. For example, query 910 may be similar to query 810 of FIG. 8, but may also include a filter that limits the request to only entities that have values of 1904, 1905, 1906, or 1007 for attribute 1. As shown in data output 920, the results are consistent with the recent updates even when filters are applied. For example, the recent update(s) may have been provided to the read system along with the read request and may have been merged into the results from the database based on query 910.

User interface screen 900 demonstrates how techniques described herein continue to produce consistent, accurate results even with more complex queries such as those involving filters. Other complex queries may also be used, such as involving a text search. For example, if a similar query to query 910 or query 810 of FIG. 8 is submitted, except including a text search such as “WHERE UPPER(attribute3) LIKE ‘%SUSHI%’” the output data may similarly remain consistent with recent updates as a result of techniques described herein.

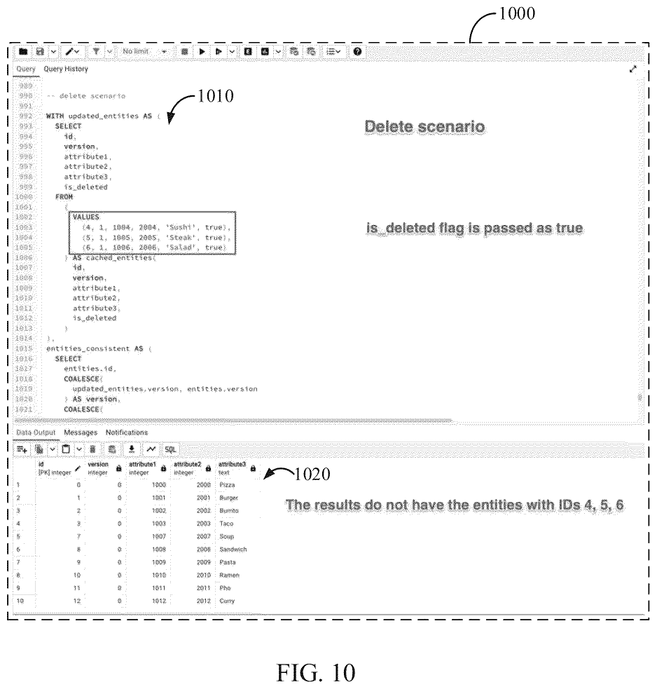

FIG. 10 is a diagram depicting another example user interface screen 1000 related to maintaining data consistency between a write database and a read database, according to certain embodiments. For example, user interface screen 1000 may represent a screen of a user interface in user interface(s)/endpoint(s) 205 of FIG. 2 that displays that displays a query 1010 (e.g., generated by a read system based on a read request input by a user or submitted by a component) and a data output 1020 in response to the query. For example, the query 1010 may correspond to a read request that is received after processing of a write request that deletes the entities having identifiers of 4, 5, and 6 but before the read system and the write system have been synchronized after the processing of the write request, and the data output 1020 may represent a response to the read request from read system 230 of FIG. 2.

Generally, user interface screen 1000 may represent an example where certain entities have recently been deleted (e.g., via a soft delete by which an “is_deleted” attribute is set to true). For example, query 1010 may be similar to query 810 of FIG. 8 and/or query 910 of FIG. 9, but may include the recent updates (e.g., from the distributed cache) indicating that the entities having IDs of 4, 5, and 6 have had the is_deleted flag set to true and may also include a filter that limits the request to only entities that have an is_deleted flag set to false. As shown in data output 1020, the results are consistent with the recent updates. For example, the recent update(s) may have been provided to the read system along with the read request and may have been merged into the results from the database based on query 1010. Thus, data output 1020 does not include the recently deleted entities having identifiers of 4, 5, and 6.

Techniques described herein may also be used in a hard delete scenario, where entities in the read database do not have an is_deleted flag. In such a case, a query may be generated that is similar to query 1010 but that causes an is_deleted flag to be considered false by default for all entities in the read database unless a recent update sets the is_deleted flag to true. For example, such a query may include code such as “COALESCE(updated_entities.is_deleted, false) AS is deleted.”

### Example Query Builder

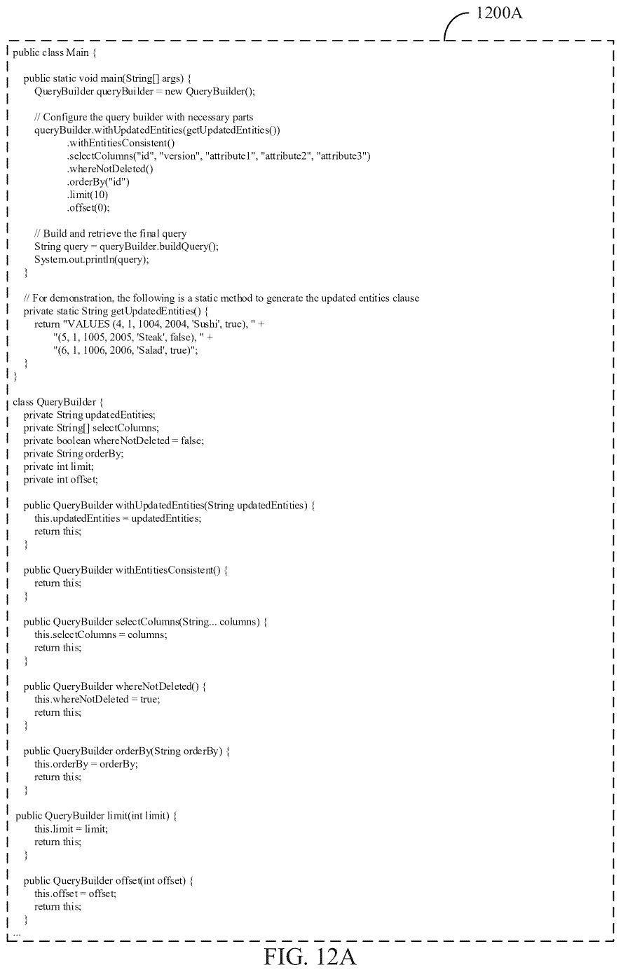

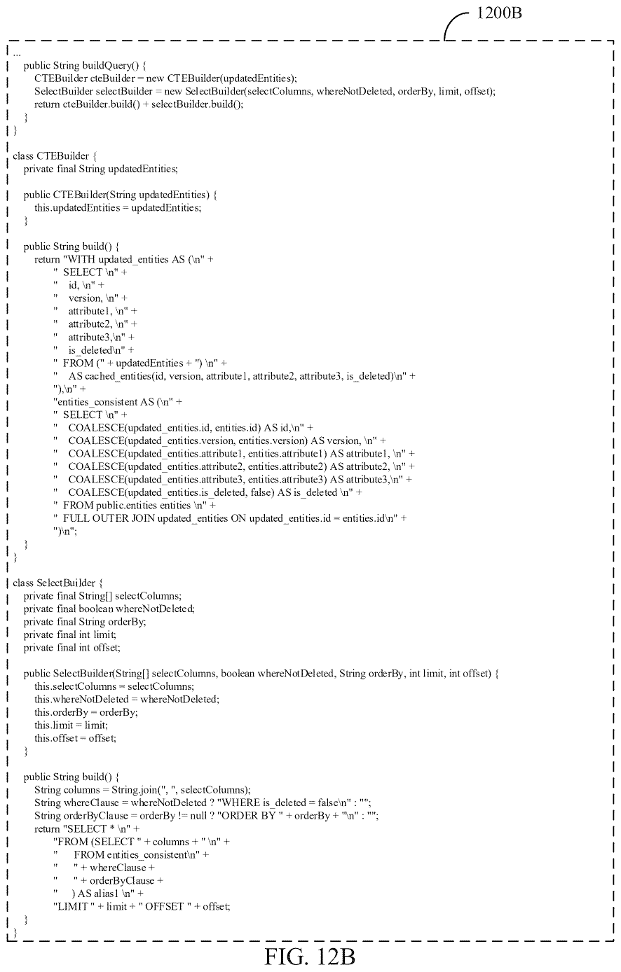

FIGS. 12A and 12B are diagrams 1200A and 1200B depicting example code related to maintaining data consistency between a write database and a read database, according to certain embodiments. For example, diagram 1200A generally represents a first half of an example section of code for generating queries by read system 230 of FIG. 2 (e.g., generating queries based on read requests and associated recent updates from the distributed cache) and 1200B generally represents a second half of the example section of code. The read system may dynamically generate a SQL query with CTEs (e.g., the query represented in FIG. 4) using the example section of code depicted in diagrams 1200A and 1200B.

For example, the code in diagram 1200A includes code for configuring a query builder, code for building and retrieving the final query, an example method for generating an updated entities clause (e.g., including specific example values), definitions of various properties such as selectColumns, whereNotDeleted, orderBy, limit, and offset, and the like. Additionally, the code in diagram 1200B includes code for a buildQuery method (that is based on selectColumns, whereNotDeleted, orderBy, limit, and offset), and classes for a CTEBuilder and SelectBuilder (e.g., for automatically building CTEs and SELECT statements for a query based on the updated entities). For example, the class for CTEBuilder causes a CTE to be built that involves selecting the identifier, version, multiple attributes, and the is_deleted flag from each of the updated entities and performing COALESCE operations to merge (e.g., via entitites_consistent) those selected values from the updated entities with the data from the read database for those entities. The class for SelectBuilder causes a SELECT statement to be built that selects certain columns where is_deleted is false, ordered in given way, and selects the requested values from the merged data (e.g., based on entities_consistent).

Generally, the query builder implemented by the example code in diagrams 1200A and 1200B may, when executed, cause a query such as that shown in FIG. 4 to be generated based on a read request and based on one or more recent updates, such as recent updates received by the read system from the orchestrator in a form such as that discussed above with respect to FIG. 3.

It is noted that the particular code and mechanisms, such as CTEs and relational databases, discussed herein are included as examples, and other implementations are possible without departing from the scope of the present disclosure.

### Example Cache Management

FIG. 13 is a diagram 1300 depicting an example of cache management techniques related to maintaining data consistency between a write database and a read database, according to certain embodiments. Diagram 1300 includes orchestrator 210, distributed cache 218, write system 220, write database 224, read system 230, read database 234, write data 212, read data 214, and data synchronization 222 of FIG. 2.

Generally, cache eviction involves removing an item from the cache when it has reached a particular threshold or when the cache has reached its maximum capacity and needs to make space for new items. Cache eviction ensures that the cache doesn't become overburdened and can continue to efficiently store and access frequently accessed data. Implementing a cache eviction strategy that ensures data remains consistent across the system while also optimizing performance can be challenging. Poorly managed cache eviction can either lead to stale data being served or excessive load on the system due to frequent cache invalidations. Thus, techniques described herein provide a robust cache eviction strategy that evicts cached data only after it has been synchronized with the read system. In some embodiments, a workflow status tracking system such as distributed workflow state manager 1318 is used to handle cache eviction events asynchronously. A workflow status tracking system generally refers to a system that monitors and records the status of workflows, often used to track the progress of processes and trigger actions based on specific status changes. Thus, aspects of the present disclosure ensure data consistency while maintaining the performance benefits of caching.

At item 1312, orchestrator 210 puts successfully updated entities in distributed cache 218 as recent updates. For example, item 1312 may represent the storing of recent updates in distributed cache 218 after such recent updates have been successfully completed by write system 220 (e.g., orchestrator 210 may determine that such write requests have been successfully completed based on confirmations from write system 220).

Diagram 1300 further includes a distributed workflow state manager 1318 that is configured to manage the state of workflow events such as relating to data synchronization 222. For example, distributed workflow state manager 1318 may receive one or more workflow events 1392 from write system 220 (e.g., relating to the initiation of a data synchronization 222) and one or more workflow events 1394 from read system 230 (e.g., relating to the completion of a data synchronization 222). In some cases, data synchronization 222 is initiated based on an event indicating that a write request has been successfully completed at write system 220, and a workflow event 1392 may be generated by write system 220 when the data synchronization 222 begins. Subsequently, a workflow event 1394 may be generated by read system 230 when the data synchronization 222 is successfully completed. Distributed workflow state manager 1318 may generate a workflow completion event 1396 upon determining the completion of a workflow such as a data synchronization 222 (e.g., based on determining from workflow events 1392 and 1394 that the data synchronization 222 is complete).

Orchestrator 210 my receive workflow completion event 1396 from distributed workflow state manager 1318 and, in response, may remove applicable recent updates from distributed cache 218 at 1314. For example, upon receiving workflow completion event 1396 (which indicates that a data synchronization 222 is complete), at 1314 orchestrator 210 may remove, from distributed cache 218, any recent updates (e.g., including a recent update stored in the cache at 1312) that were synchronized with read system 230 in the completed data synchronization 222.

Thus, techniques described herein may provide for efficient and dynamic cache management such that distributed cache 218 only stores recent updates to write system 220 that have not yet been synchronized with read system 230.

When the orchestrator 210 receives a write request from an upstream client, it may make an API request to write system 220 to perform the mutation. The recently updated entities are persisted in distributed cache 218 only if the mutation is successful in the write system 220. The distributed cache 218 will always have the latest values for a given entity id despite sequential updates on the same entity. The orchestrator 210 may listen to workflow completion events (e.g., workflow completion event 1396) from the distributed workflow state manager 1318 and may remove the recently updated entity if it is synced with the read system 230 (e.g., which may be determined based on a workflow completion event).

The write system 220 should always require the current version of the entity being updated. When the write API request has a version number that is older than the current version of the entity in the write system 220, then the write system 220 may reject the update, forcing the client to load the latest data. When multiple sequential updates on the entities happen before they are fully synchronized with the read system 230, then the cached entities always have the latest version and data. In an example, when user 1 first reads the list of entities, this is the state of the entity with ID 4 in read database 234: entity:4 “{id: 4, version: 0, attribute 1: 4, attribute 2: 4, attribute 3: ‘Sushi’”. After user 1 updates the entity, this is the contents of distributed cache 218: entity: 4 “{id: 4, version: 1, attribute1: 1904, attribute2: 2804, attribute3: ‘Sushi with avocado’}”.

Continuing the example, after user 2 updates the entity, this is the contents of distributed cache 218: entity: 4 “{id: 4, version: 2, attribute 1: 1904, attribute 2: 2804, attribute 3: ‘Sushi with avocado and brown rice}”. After user 3 updates the entity, this is the contents of distributed cache 218: entity: 4 “{id: 4, version: 3, attribute 1: 1904, attribute 2: 2804, attribute 3: ‘Sushi with avocado, brown rice & cucumber}”. Thus, distributed cache 218 always stores the latest version of each entity.

Similar results to those described herein may be achieved using a database or other data storage entity instead of a distributed cache where the recently updated entities are persisted. The same cache eviction strategies described herein may also apply to other such data structures, such as to remove the entities once they are fully synchronized.

In some aspects, queries, especially those involving CTEs, may be regularly reviewed and optimized to ensure they are performant even as data scales. Furthermore, indexing strategies and query optimization techniques may be implemented in order to reduce performance overhead, ensuring that the system remains responsive under load. Furthermore, comprehensive testing and monitoring systems may be employed to detect inconsistencies or performance bottlenecks early. For example, automated tests may be performed for concurrency issues and real-time monitoring of system performance. Concurrency generally refers to the ability of a system to handle multiple tasks simultaneously, and is particularly relevant in databases where multiple users or processes may attempt to access or modify data at the same time. Such techniques may allow for early detection of issues and quicker resolution, reducing the risk of prolonged user impact.

### Example Operations for Maintaining Data Consistency Between a Write Database and a Read Database

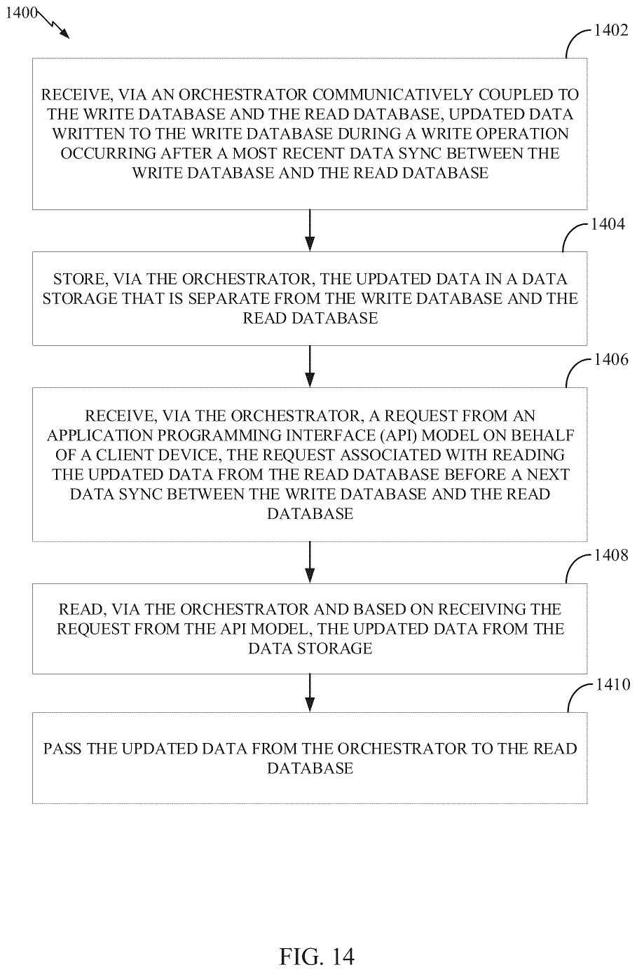

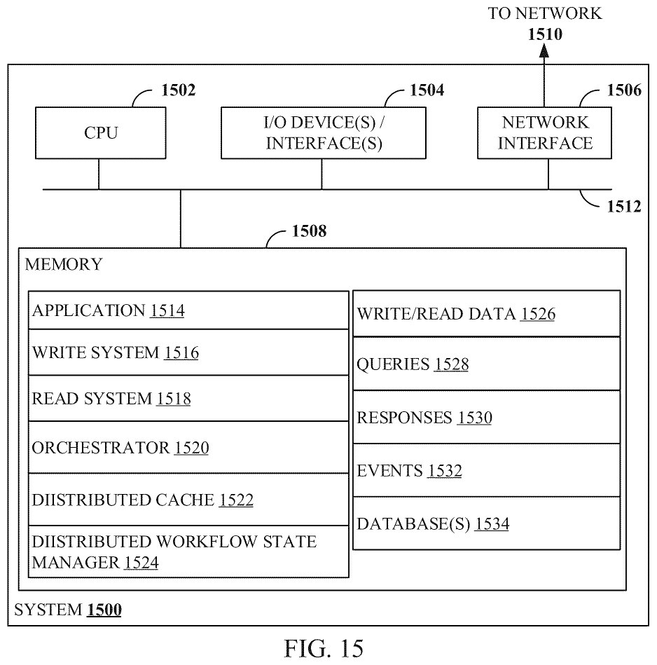

FIG. 14 depicts example operations 1400 related to maintaining data consistency between a write database and a read database, according to certain embodiments. For example, operations 1400 may be performed by one or more components described above with respect to FIG. 2, system 1500 of FIG. 15 (described below), and/or one or more other components and/or devices.

Operations 1400 begin at step 1402, with receiving, via an orchestrator communicatively coupled to the write database and the read database, updated data written to the write database during a write operation occurring after a most recent data sync between the write database and the read database.

Operations 1400 continue at step 1404, with storing, via the orchestrator, the updated data in a data storage that is separate from the write database and the read database.

Operations 1400 continue at step 1406, with receiving, via the orchestrator, a request from an application programming interface (API) model on behalf of a client device, the request associated with reading the updated data from the read database before a next data sync between the write database and the read database.

Operations 1400 continue at step 1408, with reading, via the orchestrator and based on receiving the request from the API model, the updated data from the data storage.

Operations 1400 continue at step 1410, with passing the updated data from the orchestrator to the read database. For example, passing the updated data from the orchestrator to the read database may refer to passing the updated data from the orchestrator to a read system associated with the read database, and the read system may merge the updated data with existing data stored in the read database using the SQL query structure and the CTEs.

In some embodiments, passing the updated data to the read database comprises dynamically generating a structure query language (SQL) query structure with common table expressions (CTEs) based on a mapping of the updated data stored in the data storage to respective columns of the read database and merging the updated data stored in the data storage with existing data stored in the read database using the SQL query structure and the CTEs.

Certain embodiments comprise returning, via the read database, the updated data to the API model as a response to the request. In some embodiments, the write operation comprises writing a new record to the write database, the new record having a unique identifier and a value, and storing the updated data in the data storage comprises storing, via the orchestrator, the unique identifier for the new record and the value for the new record.

In some embodiments, the write operation comprises modifying a value for an existing record stored in the write database and storing the updated data in the data storage comprises storing, via the orchestrator, a unique identifier for the existing record and the modified value for the existing record. In certain embodiments, the write operation comprises deleting a value for an existing record stored in the write database and storing the updated data in the data storage comprises storing, via the orchestrator, a unique identifier for the existing record and data indicating the value for the existing record has been deleted.

In certain embodiments, the request is an API call and passing the updated data to the read database comprises modifying the API call to include the updated data and passing the modified API call to the read database.

In some embodiments, the data storage comprises a distributed cache and the read database comprises a relational database configured to store data in predefined relationships in which data is stored in or more tables of columns and rows.

Notably, method 1400 is just one example with a selection of example steps, but additional methods with more, fewer, and/or different steps are possible based on the disclosure herein.

### Example Computing System

FIG. 15 illustrates an example computing system 1500 with which embodiments of the disclosure related to maintaining data consistency between a write database and a read database may be implemented. For example, the computing system 1500 may perform functionality described above with respect to FIGS. 1-13, and/or may perform operations 1400 of FIG. 14.

The computing system 1500 includes a central processing unit (CPU) 1502, one or more I/O device interfaces 1504 that may allow for the connection of various I/O devices 1504 (e.g., keyboards, displays, mouse devices, pen input, etc.) to the computing system 1500, a network interface 1506, a memory 1508, and an interconnect 1512. It is contemplated that one or more components of the computing system 1500 may be located remotely and accessed via a network 1510. It is further contemplated that one or more components of the computing system 1500 may include physical components or virtualized components.

The CPU 1502 may retrieve and execute programming instructions stored in the memory 1508. Similarly, the CPU 1502 may retrieve and store application data residing in the memory 1508. The interconnect 1512 transmits programming instructions and application data, among the CPU 1502, the I/O device interface 1504, the network interface 1506, the memory 1508. The CPU 1502 is included to be representative of a single CPU, multiple CPUs, a single CPU having multiple processing cores, and other arrangements.

Additionally, the memory 1508 is included to be representative of a random access memory or the like. In some embodiments, the memory 1508 may include a disk drive, solid state drive, or a collection of storage devices distributed across multiple storage systems. Although shown as a single unit, the memory 1508 may be a combination of fixed and/or removable storage devices, such as fixed disc drives, removable memory cards or optical storage, network attached storage (NAS), or a storage area-network (SAN).

As shown, the memory 1508 includes an application 1514 which may be representative of a computing application that provides functionality described herein related to maintaining data consistency between a write database and a read database. Memory 1508 further includes write system 1516, read system 1518, orchestrator 1520, and distributed cache 1522, which may be representative of write system 220, read system 230, orchestrator 210, and distributed cache 218 of FIG. 2.

Memory 1508 further includes distributed workflow state manager 1524, which may be representative of distributed workflow state manager 1318 of FIG. 13. Memory 1508 further includes write/read data 1526, which may include write and read data 208, write data 212, and read data 214 of FIGS. 2 and 13. Memory 1508 further includes queries 1528, which may include the query depicted in FIG. 4 and/or one or more of the queries 610, 810, 910, 1010, and 1110 of FIGS. 6, 8, 9, 10, and 11.

Memory 1508 further includes responses 1530, which may include responses to queries 1528, such as including one or more of data outputs 620, 820, 920, 1020, and 1120 of FIGS. 6, 8, 9, 10, and 11. Memory 1508 further includes events 1532, which may include events related to write requests, data synchronization, and/or the like, such as including workflow event(s) 1392, workflow event(s) 1394, and/or workflow completion event 1395 of FIG. 13. Memory 1508 further includes database(s) 1534, which may include write database 224 and/or read database 234 of FIGS. 2 and 13.

It is noted that system 1500 is included as an example, and certain functionality described with respect to system 1500 and/or otherwise described herein may be implemented via more or fewer devices and/or components.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for maintaining data consistency between a write database and a read database, comprising:
receiving, via an orchestrator that is external to the write database and the read database, updated data written to the write database during a write operation occurring after a most recent data sync between the write database and the read database;
providing, via the orchestrator, a write request to the write database, the write request comprising the updated data;
responsive to determining the updated data was written to the write database, storing, via the orchestrator, the updated data in a data storage that is separate from the write database and the read database;
receiving, via the orchestrator, a request from an application programming interface (API) model on behalf of a client device, the request associated with reading the updated data from the read database before a next data sync between the write database and the read database;
reading, via the orchestrator and based on receiving the request from the API model, the updated data from the data storage; and
passing the updated data from the orchestrator to the read database.

2. The method of claim 1, wherein passing the updated data to the read database comprises:
dynamically generating a structure query language (SQL) query structure with common table expressions (CTEs) based on a mapping of the updated data stored in the data storage to respective columns of the read database; and
merging the updated data stored in the data storage with existing data stored in the read database using the SQL query structure and the CTEs.

3. The method of claim 2, further comprising:
returning, via the read database, the updated data to the API model as a response to the request.

4. The method of claim 1, wherein:
the write operation comprises writing a new record to the write database, the new record having a unique identifier and a value; and
storing the updated data in the data storage comprises storing, via the orchestrator, the unique identifier for the new record and the value for the new record.

5. The method of claim 1, wherein:
the write operation comprises modifying a value for an existing record stored in the write database; and
storing the updated data in the data storage comprises storing, via the orchestrator, a unique identifier for the existing record and the modified value for the existing record.

6. The method of claim 1, wherein:
the write operation comprises deleting a value for an existing record stored in the write database; and
storing the updated data in the data storage comprises storing, via the orchestrator, a unique identifier for the existing record and data indicating the value for the existing record has been deleted.

7. The method of claim 1, wherein:
the request is an API call; and
passing the updated data to the read database comprises:
modifying the API call to include the updated data; and
passing the modified API call to the read database.

8. The method of claim 1, wherein:
the data storage comprises a distributed cache; and
the read database comprises a relational database configured to store data in predefined relationships in which data is stored in one or more tables of columns and rows.

9. A system for maintaining data consistency between a write database and a read database, comprising:
one or more processors; and
a memory comprising instructions that, when executed by the one or more processors, cause the system to:
receive, via an orchestrator that is external to the write database and the read database, updated data written to the write database during a write operation occurring after a most recent data sync between the write database and the read database;
provide, via the orchestrator, a write request to the write database, the write request comprising the updated data;
responsive to determining the updated data was written to the write database, store, via the orchestrator, the updated data in a data storage that is separate from the write database and the read database;
receive, via the orchestrator, a request from an application programming interface (API) model on behalf of a client device, the request associated with reading the updated data from the read database before a next data sync between the write database and the read database;
read, via the orchestrator and based on receiving the request from the API model, the updated data from the data storage; and
pass the updated data from the orchestrator to the read database.

10. The system of claim 9, wherein passing the updated data to the read database comprises:
dynamically generating a structure query language (SQL) query structure with common table expressions (CTEs) based on a mapping of the updated data stored in the data storage to respective columns of the read database; and
merging the updated data stored in the data storage with existing data stored in the read database using the SQL query structure and the CTEs.

11. The system of claim 10, wherein the instructions, when executed by the one or more processors, further cause the system to:
return, via the read database, the updated data to the API model as a response to the request.

12. The system of claim 9, wherein:
the write operation comprises writing a new record to the write database, the new record having a unique identifier and a value; and
storing the updated data in the data storage comprises storing, via the orchestrator, the unique identifier for the new record and the value for the new record.

13. The system of claim 9, wherein:
the write operation comprises modifying a value for an existing record stored in the write database; and
storing the updated data in the data storage comprises storing, via the orchestrator, a unique identifier for the existing record and the modified value for the existing record.

14. The system of claim 9, wherein:
the write operation comprises deleting a value for an existing record stored in the write database; and
storing the updated data in the data storage comprises storing, via the orchestrator, a unique identifier for the existing record and data indicating the value for the existing record has been deleted.

15. The system of claim 9, wherein:
the request is an API call; and
passing the updated data to the read database comprises:
modifying the API call to include the updated data; and
passing the modified API call to the read database.

16. The system of claim 9, wherein:
the data storage comprises a distributed cache; and
the read database comprises a relational database configured to store data in predefined relationships in which data is stored in one or more tables of columns and rows.

17. A non-transitory computer readable medium comprising instructions that, when executed by one or more processors of a computing system, cause the computing system to:
receive, via an orchestrator that is external to a write database and a read database, updated data written to the write database during a write operation occurring after a most recent data sync between the write database and the read database;
provide, via the orchestrator, a write request to the write database, the write request comprising the updated data;
responsive to determining the updated data was written to the write database, store, via the orchestrator, the updated data in a data storage that is separate from the write database and the read database;
receive, via the orchestrator, a request from an application programming interface (API) model on behalf of a client device, the request associated with reading the updated data from the read database before a next data sync between the write database and the read database;
read, via the orchestrator and based on receiving the request from the API model, the updated data from the data storage; and
pass the updated data from the orchestrator to the read database.

18. The non-transitory computer readable medium of claim 17, wherein passing the updated data to the read database comprises:
dynamically generating a structure query language (SQL) query structure with common table expressions (CTEs) based on a mapping of the updated data stored in the data storage to respective columns of the read database; and
merging the updated data stored in the data storage with existing data stored in the read database using the SQL query structure and the CTEs.

19. The non-transitory computer readable medium of claim 18, wherein the instructions, when executed by the one or more processors, further cause the computing system to:
return, via the read database, the updated data to the API model as a response to the request.

20. The non-transitory computer readable medium of claim 17, wherein:
the write operation comprises writing a new record to the write database, the new record having a unique identifier and a value; and
storing the updated data in the data storage comprises storing, via the orchestrator, the unique identifier for the new record and the value for the new record.
